(19) United States
(12) Patent Application Publication
(10) Pub. No.: US 2011/0232995 A1
(43) Pub. Date: Sep. 29, 2011

(54) ROPING DEVICES

(75) Inventor: Boris Rogelja, Hurstville Grove (AU)

(73) Assignee: Capital Safety Group (Australia) Pty Ltd

(21) Appl. No.: 13/152,563

(22) Filed: Jun. 3, 2011

Related U.S. Application Data
(62) Division of application No. 10/592,637, filed on Mar. 7, 2008.

(30) Foreign Application Priority Data
Mar. 22, 2004 (AU) 2004901507

(51) Int. Cl. A62B 1/14; A62B 1/06

(52) U.S. Cl. 182/5; 182/3

(57) ABSTRACT

A roping device used by a person descending from a height is provided. The roping device is for use with a rope and includes first, second and third plates and a first rotatable sheave. The first plate has a first face and an opposed second face. The second plate has a first face and an opposed second face. The first rotatable sheave is rotatably coupled between the second face of the first plate and the first face of the second plate. The first rotatable sheave is configured and arranged to engage the rope in at least a partial block and tackle arrangement to increase a mechanical advantage. The third plate extends from the first plate at a select angle in a direction towards the second plate proximate the first rotatable sheave. The third plate has an attachment point that is positioned proximate a center of the roping device.

### CROSS-REFERENCE TO RELATED APPLICATIONS

This application is a Divisional of U.S. patent application Ser. No. 10/592,637, filed Mar. 7, 2008, and entitled ROPING DEVICES, which is a National Stage entry under 35 U.S.C. §371 of International Patent Application Serial No. PCT/AU2005/000385, filed Mar. 17, 2005, entitled IMPROVED ROPING DEVICE and which claims priority from Australian Patent Application No. 2004901507, filed Mar. 22, 2004.

### FIELD OF THE INVENTION

The present invention relates to improved roping devices and in particular, to devices which are suitable for use by a person who wishes to safely descend a shear face of a building, cliff or the like.

### BACKGROUND OF THE INVENTION

If a person needs to descend from a height, by for example, climbing down a ladder, cliff face or the like, for safety reasons, it is often necessary for the person to be attached in some way to the ladder or to a convenient securing point, so that in the event that the person slips and falls, he or she will be prevented from falling to the ground. Clearly, any device for this purpose should preferably be as small and unobtrusive as possible in use, to allow the user to make the decent without significant interference. Such roping devices are often used by workers such as window cleaners and other workers maintaining the exteriors of sky scrapers and the like.

Any discussion of documents, acts, materials, devices, articles or the like which have been included in the present specification are solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment a roping device for operating on a rope is provided. The device includes a first plate, a first attachment point, a first rotatable sheave, a braking mechanism and a second plate. The first plate has a front face and a reverse face. The first attachment point is used for attachment of one end of the rope. The first rotatable sheave is operationally connected to the reverse face of the first plate. The front face of the first plate defines a generally straight guide path for an opposite and free end of the rope. The braking mechanism is operationally connected to the front face of the first plate proximate the guide path. The braking mechanism is configured and arranged for selectively braking the free end of the rope. The second plate is connected to the first plate and is angularly offset at an acute angle relative to the first plate. The second plate has a second attachment point proximate the braking mechanism and positioned generally towards a center of the roping device. The rope is at the said one end, attached to the first attachment point. The rope is further in a block and tackle arrangement that passes around the first sheave. The second attachment point generally aligns vertically with the first sheave whereby loading of the roping device proximate the first and the second attachment points substantially balances the roping device.

In another embodiment, another roping device for use with a rope is provided. The roping device includes a first plate, a second plate, a first rotatable sheave and a third plate. The first plate has a first face and an opposed second face. The second plate has a first face and an opposed second face. The first rotatable sheave is rotatably coupled between the second face of the first plate and the first face of the second plate. The first rotatable sheave is configured and arranged to engage the rope in at least a partial block and tackle arrangement to increase a mechanical advantage. The third plate extends from the first plate at a select angle in a direction toward the second plate proximate the first rotatable sheave. The third plate has an attachment point that is positioned proximate a center of the roping device.

In still another embodiment, a safety rope apparatus is provided. The safety rope apparatus includes a sheave block and a roping device. The sheave block includes at least one block sheave. The sheave block has a sheave block attachment point that is configured and arranged for use in coupling the sheave block to a secure support structure. The roping device has a first end and a second end. The roping device also includes at least one roping sheave. The at least one roping sheave and the at least one block sheave are configured and arranged to engage a rope in a block and tackle fashion to achieve a mechanical advantage. The roping device has a first roping attachment point proximate the first end of the roping device. The first roping attachment point is configured and arranged to couple an end of the rope to the roping device. The roping device further including a second roping attachment point proximate the second end of the roping device. The second roping attachment point is positioned proximate a balancing center of the roping device to provide balance and stability to the safety rope apparatus when in use.

### BRIEF DESCRIPTION OF THE DRAWINGS

A specific embodiment of the present invention will now be described by way of example only and with reference to the accompanying drawings in which:

FIG. 1 shows a first roping device and associated sheave block;

FIG. 1a is a diagram of the roping device of FIG. 1;

FIG. 2 is a side view of the roping device shown in FIG. 1;

FIG. 3 shows a second embodiment of a roping device and sheave block for single person operation;

FIG. 4 shows an enlarged view of the roping device of FIG. 3;

FIG. 5 shows a side view of the roping device shown in FIG. 4; and

FIG. 6 is an end view of the roping device of FIG. 3.

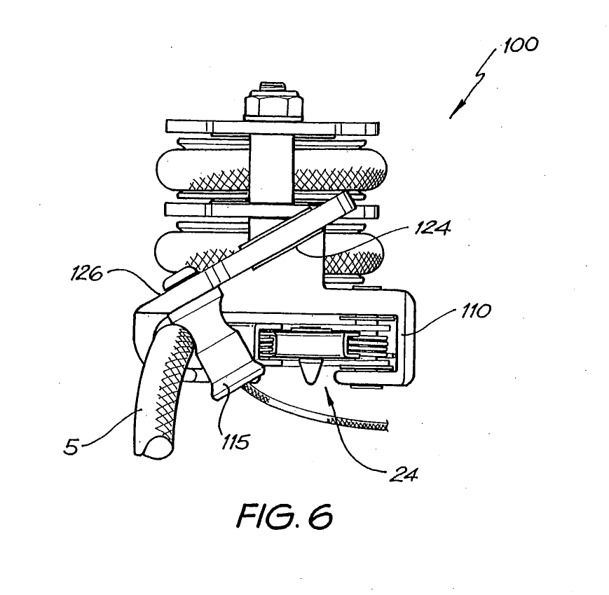

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments described herein are typically used with a sheave block defining one or more sheaves. A second sheave, coaxial with the first sheave may be provided. In use, a rope is attached to the first attachment means on the roping device passes up and around a sheave of the sheave block and back to the roping device then passes along the path adjacent the braking mechanism. The sheave block includes attachment means for attaching a sheave block to a secure attachment point. A person descending from a height attaches themselves to the second attachment means on the roping device and being adjacent the braking mechanism of the rope can easily adjust and control the mechanism to control their descent without assistance from a second person.

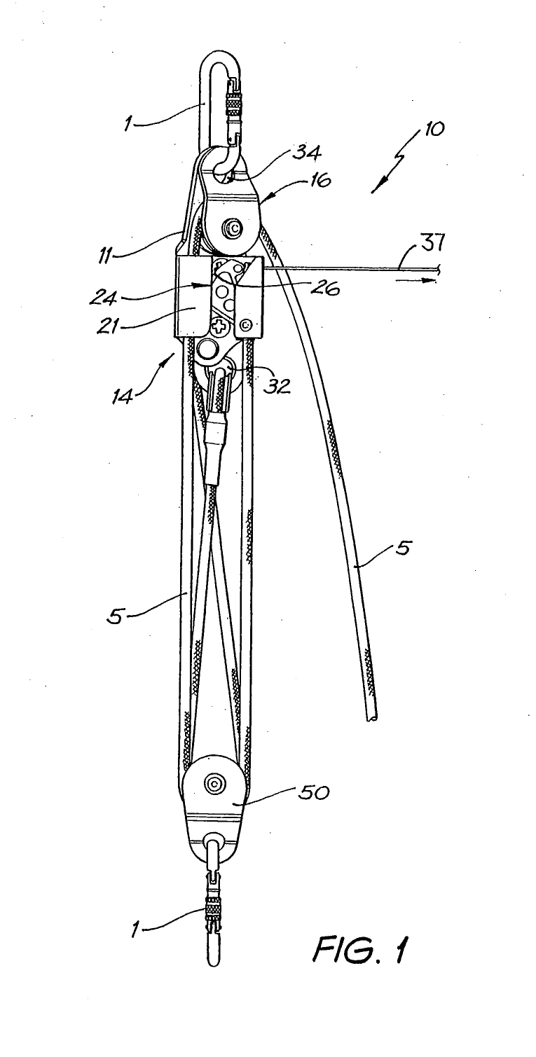

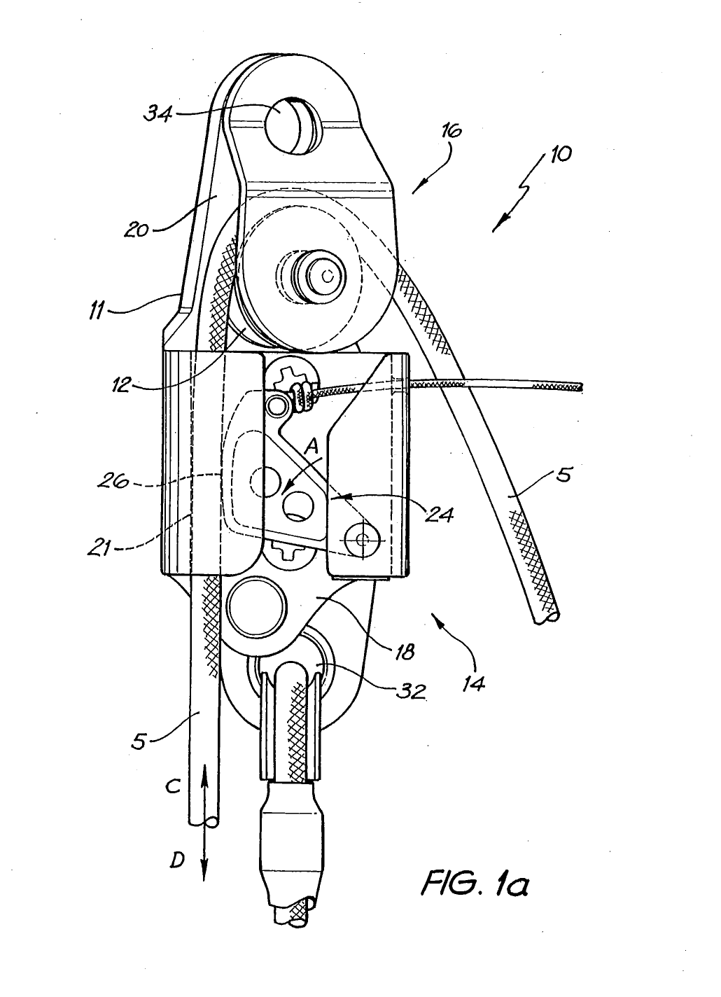

Referring to the drawings, FIG. 1 shows a first roping device generally indicated at 10 comprising a body portion 11, a first rotatable sheave 12 (hidden and shown in dashed outline in FIG. 1a). The body is generally elongate and has two distinct sections 14 and 16. Both body sections define a flat plate being first and second flat plates 18 and 20, respectively.

As is best seen in FIG. 1a, the lower part 14 of the roping device defines a part of a guide path for a rope 5 including a generally U-shaped channel 21 which extends along one side of the plate 18. A braking mechanism 24 is mounted on the side of the plate which defines the channel and defines a curved braking surface 26 which is adapted to frictionally engage the rope 5. The surface 26 defines an array of small spikes (not illustrated in the drawings). The braking member 24 is biased in the direction A into an engaged position in which a rope 5 passing along the guide path is wedged between the braking surface 26 and an opposing part of the U-shaped channel 21 preventing the rope from being pulled in the direction D. When a tension force is applied in the opposite direction C, the braking member 26 allows the rope to freely pass through the U-shaped channel 21. In a variant (not shown), the braking mechanism 24 also includes a latch pivotally mounted on the braking member which can be moved against the biasing force into an open position into a fully retracted position.

The device 10 includes first and second attachment points 34, 32 in the form of holes in the first and second plates, respectively. Hole 34 is intended to allow the user to connect the device by way of a carabiner 1 to a rung of a ladder or other convenient fixing point. As shown in FIG. 1 the other hole 32 can be used to connect one end of the rope 5 to the device 10 when it is being used as a part of a block and tackle arrangement as shown in FIG. 1 of the drawings.

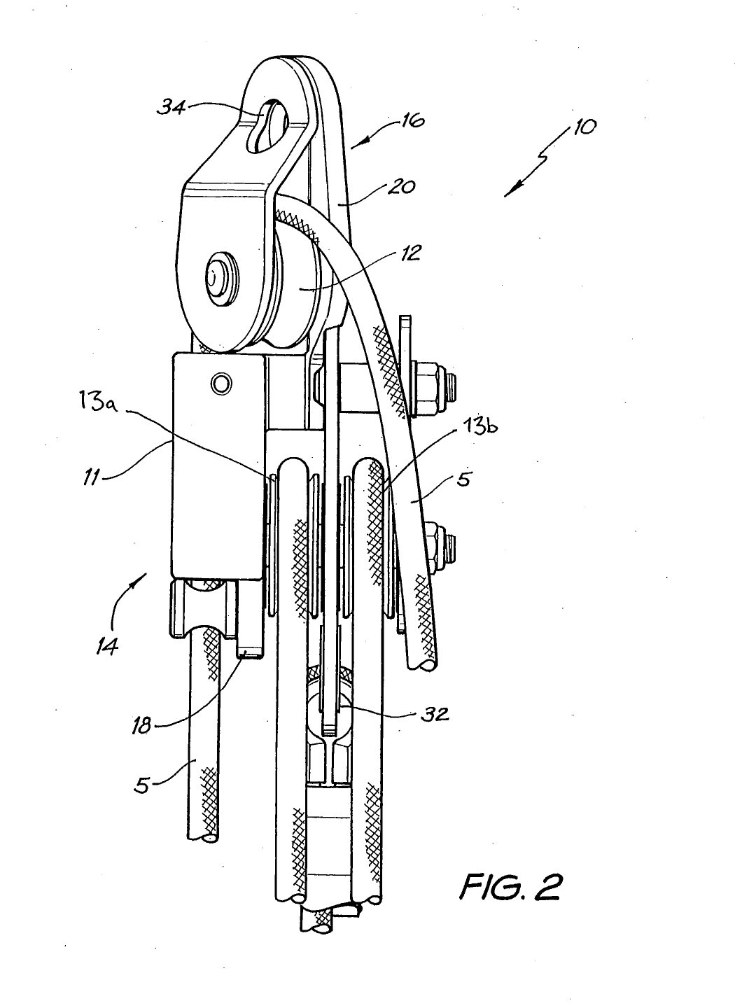

As illustrated in FIG. 2 in particular, the plate 18 lies in a plane which meets the plate 20 at an acute angle of approximately 20-25°. Because of this, the rope 5 passing around the sheave 12 can pass behind the part 14 of the roping device avoiding contact with the front part of the roping device and preventing wear and tear on the rope. This arrangement also allows sheave 12 to be much smaller than what would otherwise be required to prevent abrasion of the rope 5 in use. The sheave is about 4.5 cm in diameter which is narrower than the width of the plate 18 which is about 7.5 cm.

FIG. 2 also shows two additional co-axial rotatable sheaves 13a and 13b located on the reverse face of the first plate 18 for use with a block and tackle arrangement to increase mechanical advantage. In a variant, one or two additional sheaves could instead be located behind the second plate 20.

As shown in FIG. 1, the device 10 is used in conjunction with a sheave block 50 having first and second sheaves and which is attached by way of a carabiner 1 to the person or object being lowered. One end of the rope is attached to the attachment point 32 of the device. The rope extends down to the sheave block, around one sheave, back up to the device 10, around to the sheave 13a, passing behind the plate 20, around down to the first sheave of the sheave block, up towards the roping device, around the sheave 13b, down to the sheave block 12 through the channel 21 and braking mechanism 24. The tail end of the rope should be free to feed into the device as the user descends. In FIG. 1 tension t is applied to a length of string 37, pulling the braking mechanism out of engagement to allow the rope to freely run through the channel 21.

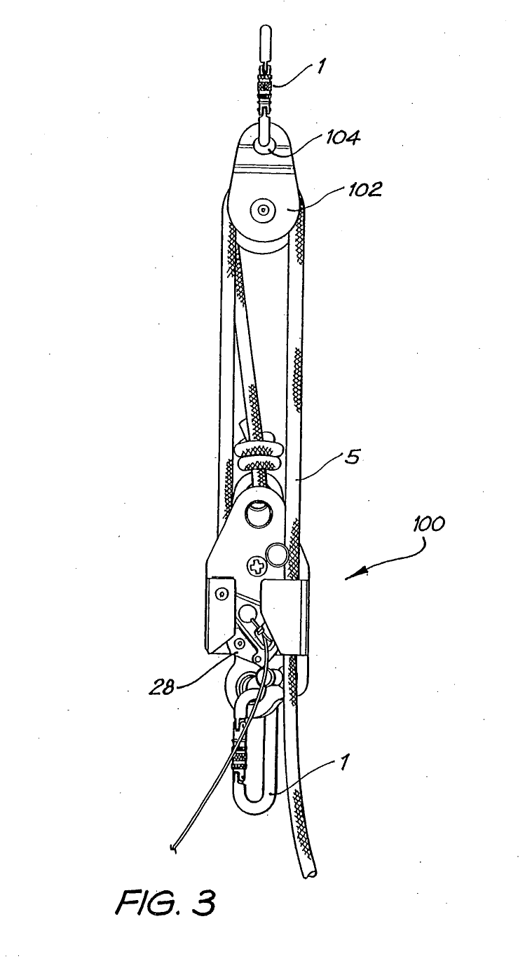

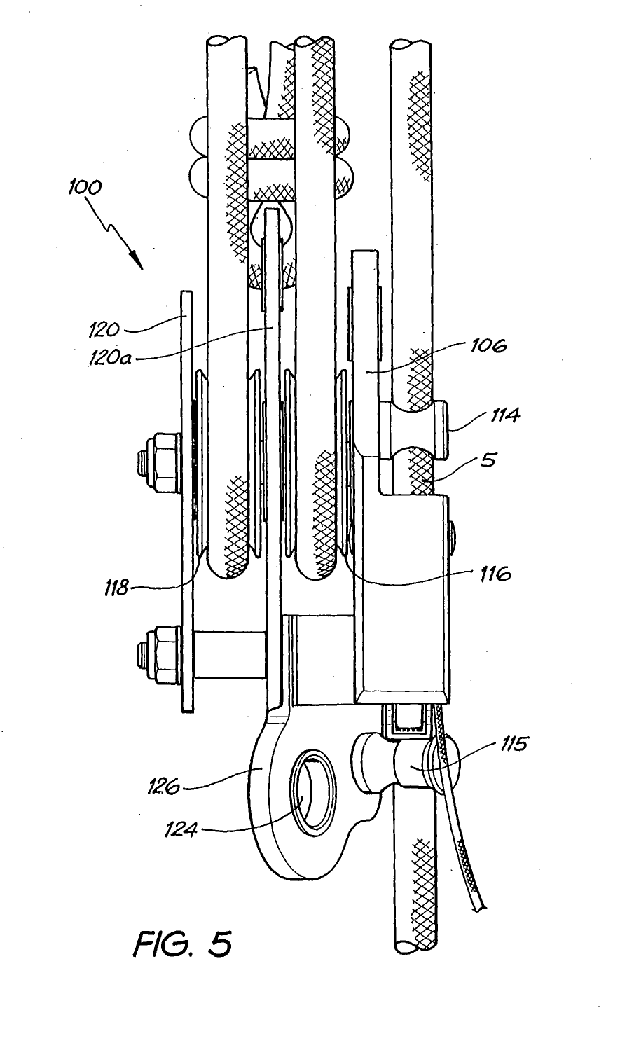

A second embodiment of a roping device 100 is shown in FIGS. 3 to 5. In contrast with the first roping device, this device can be operated by a single person. The roping device 100 is used in conjunction with a sheave block 102 having three rotatable sheaves. The sheave block 102 defines an attachment point 104 in the form of a hole which is attached by way of a carabiner 1 to a rung of a ladder or other secure attachment point.

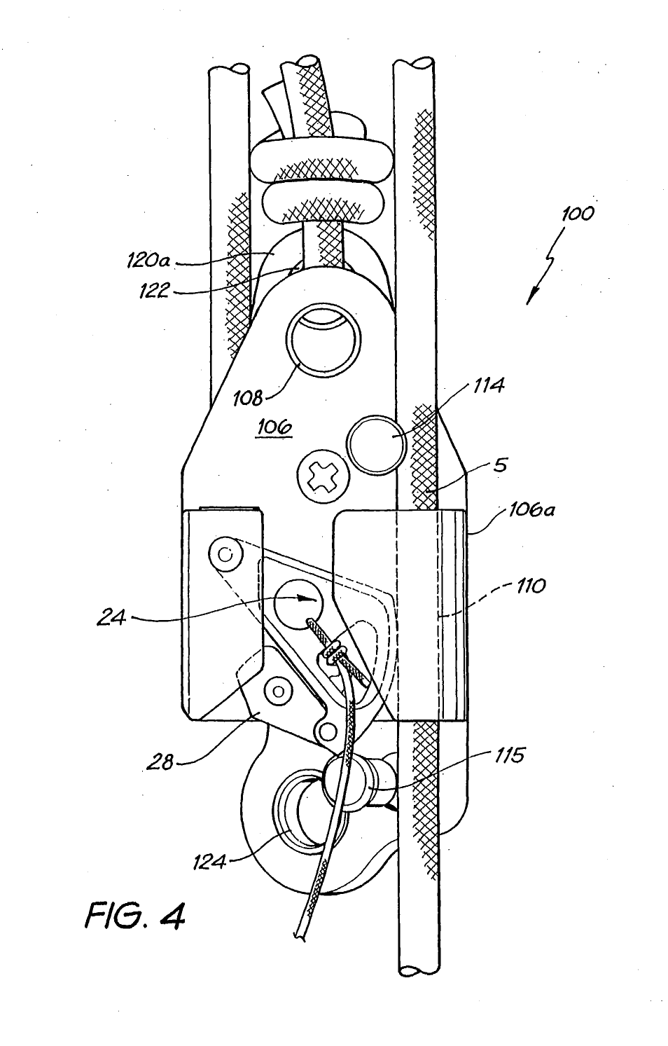

Roping device 100 is shown in more detail in FIG. 4. The device defines a front plate 106 which defines an attachment point 108 in the form of a hole at one end. The front plate defines a generally U-shaped channel 110 extending at a predetermined distance along a side edge 106a of the plate. The device includes a braking mechanism 24 which is identical to the braking mechanism described in relation to the first embodiment and will not be described in detail in relation to this embodiment. Bosses 114 and 115 help control the path of a rope 5 through the device and to contain the rope 5 in the channel 110. Two rotatable sheaves 116 and 118 are disposed behind the plate 106 for rotation about an axis which is perpendicular to the plate 106. A plate 120 is disposed between the two sheaves. The upper end 120a of the plate, in use, defines an attachment point 122 in the form of a hole which projects further than the attachment point 108 defined in the plate 106.

A second attachment point 124 is defined at the base of the roping device in use. This is defined in a plate 126 which extends from the longitudinal edge 106a away from the front plate at an acute angle to the same of approximately 20-25°. In this way, the attachment point defined at the lower end of the device in use, is located generally towards the center of the roping device and this improves the balance and stability of the apparatus, in use.

In use as shown in FIG. 3 a worker attaches the attachment point 104 of the sheave block 50 to a secure attachment point on the building or the like which they are to descend. The roping device 100 is attached by way of a further carabiner to a harness. The worker can easily control the braking mechanism 24 to allow rope to pass through the guide channel 110 when descending.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A roping device for use with a rope, said device comprising:
a first plate having a front face and a reverse face;
a first attachment point for attachment of one end of the rope;
a first rotatable sheave operationally connected to the reverse face of the first plate, the front face of the first plate defining a generally straight guide path for an opposite and free end of the rope;
a braking mechanism operationally connected to the front face of the first plate proximate the guide path, the braking mechanism being configured and arranged for selectively braking the free end of the rope; and
a second plate connected to the first plate and angularly offset at an acute angle relative to the first plate, the second plate having a second attachment point proximate the braking mechanism and positioned generally towards a center of the roping device wherein the rope is at the said one end attached to the first attachment point and in a block and tackle arrangement passes around the first sheave wherein the second attachment point generally aligns vertically with the first sheave whereby loading of the roping device proximate the first and the second attachment points substantially balances the roping device.

2. The roping device as claimed in claim 1, further comprising:
a third plate disposed parallel to and separated from the first plate with the first sheave mounted therebetween, the third plate having the first attachment point located proximate an opposite end of the device relative to the second attachment point.

3. The roping device as claimed in claim 2, wherein the third plate is operationally connected to the second plate and the second plate is positioned intermediate the first and the third plates.

4. The roping device as claimed in claim 2, further comprising:
a second sheave mounted on a reverse face of the third plate.

5. The roping device as claimed in claim 1, wherein the first attachment point is located on the first plate proximate an opposite end of the device relative to the second attachment point.

6. The roping device of claim 1, wherein the second plate is offset at the acute angle of about 20 to 25° to the first plate.

7. A roping device for use with a rope comprising:
a first plate having a first face and an opposed second face;
a second plate having a first face and an opposed second face;
a first rotatable sheave rotatably coupled between the second face of the first plate and the first face of the second plate, the first rotatable sheave configured and arranged to engage the rope in at least a partial block and tackle arrangement to increase a mechanical advantage; and
a third plate extending from the first plate at a select angle in a direction toward the second plate proximate the first rotatable sheave, the third plate having an attachment point that is positioned proximate a center of the roping device.

8. The roping device of claim 7, further comprising:
the first plate further having a top edge and an opposed bottom edge, the first plate having a first upper attachment point proximate the top edge of the first plate, the first upper attachment point configured and arranged to couple the roping device to an end of the rope.

9. The roping device of claim 7, further comprising:
the second plate further having a top edge and an opposed bottom edge, the second plate having a second upper attachment point proximate the top edge of the second plate, the second upper attachment point configured and arranged to couple the roping device to an end of the rope.

10. The roping device of claim 7, further comprising:
the first plate further having a top edge and an opposed bottom edge;
the second plate further having a top edge and an opposed bottom edge; and
the third plate extending from the first plate towards the second plate under the first sheave at the select angle.

11. The roping device of claim 7, further comprising;
a guide extending from the first face of the first plate to guide a portion of the rope.

12. The roping device of claim 11, wherein the guide further comprises:
a formed U-shaped channel and at least one boss.

13. The roping device of claim 7, further comprising:
a fourth plate; and
a second sheave rotatably coupled between the second face of the second plate and the fourth plate, the second rotatable sheave configured and arranged to engage the rope in at least a partial block and tackle arrangement to increase a mechanical advantage.

14. The roping device of claim 7, wherein the third plate is offset at the acute angle of about 20 to 25° to the first plate.

15. A safety rope apparatus, comprising:
a sheave block including at least one block sheave, the sheave block having a sheave block attachment point configured and arranged for use in coupling the sheave block to a secure support structure; and
a roping device having a first end and a second end, the roping device also including at least one roping sheave, the at least one roping sheave and the at least one block sheave configured and arranged to engage a rope in a block and tackle fashion to achieve a mechanical advantage, the roping device having a first roping attachment point proximate the first end of the roping device, the first roping attachment point configured and arranged to couple an end of the rope to the roping device, the roping device further including a second roping attachment point proximate the second end of the roping device, the second roping attachment point positioned proximate a balancing center of the roping device to provide balance and stability to the safety rope apparatus when in use.

16. The safety rope apparatus of claim 15, wherein the roping device further comprises:
a first plate having a first face and an opposed second face;
a second plate having a first face and an opposed second face;
the at least one roping sheave including a first roping sheave rotatably coupled between the second face of the first plate and the first face of the second plate, the first roping sheave configured and arranged to engage the rope in at least a partial block and tackle arrangement to increase a mechanical advantage; and
a third plate extending from the first plate at a select angle toward a direction of the second plate proximate the second end of the roping device, the third plate including the second attachment point.

17. The safety rope apparatus of claim 16, further comprising:
a fourth plate; and
the at least one roping sheave including a second roping sheave rotatably coupled between the second face of the second plate and the fourth plate, the second roping sheave configured and arranged to engage the rope in at least a partial block and tackle arrangement to increase a mechanical advantage.

18. The safety rope apparatus of claim 16, wherein the third plate is offset at the acute angle of about 20 to 25° to the first plate.

19. The safety rope apparatus of claim 16, wherein the roping device further comprises:
a U-shaped guide extending from the first face of the first plate to guide a portion of the rope.

20. The safety rope apparatus of claim 16, wherein the second roping attachment point is configured and arranged to couple the roping device to a safety harness of a worker via carabiner.
